(19) United States
(12) Patent Application Publication
(10) Pub. No.: US 2006/0029367 A1
(43) Pub. Date: Feb. 9, 2006

(54) Sequence header identification

(76) Inventors: Takuya Kosugi, San Diego, CA (US); Shyh-Jye Anthony Chen, San Diego, CA (US)

Correspondence Address: MILLER PATENT SERVICES, 2500 DOCKERY LANE, RALEIGH, NC, 27606, US

(21) Appl. No.: 10/910,664

(22) Filed: Aug. 3, 2004

(51) Int. Cl. H04N 5/783; H04N 5/781

(52) U.S. Cl. 386/69; 386/70

(57) ABSTRACT

A method of storing a video stream consistent with certain embodiments involves assigning an sequence header identifier to each sequence of video in the video stream that uses the same sequence header payload; storing the sequence header identifier in an index table that indexes the sequence header identifier to the sequence header; and storing a reference to the sequence header identifier in a manner that associates the video data with the sequence header identifier. A method of playing the stored video according to certain embodiments involves determining that a command that calls for a jump to a new frame of the stored video has been issued; identifying a sequence header identifier associated with the new frame of video; finding a sequence header associated with the sequence header identifier; deciding whether loading sequence header can be skipped or not; loading the sequence header's payload into a decoder; and decoding the new frame of video. This abstract is not to be considered limiting, since other embodiments may deviate from the features described in this abstract.

### BACKGROUND

Sequence headers are used in MPEG (Moving Pictures Expert Group) compliant video formats to provide certain data used for decoding and presentation of a video image. Other video formats may utilize similar headers. MPEG sequence headers provide information such as image height and width, color space, frame rate, frame size, etc. This information is used for a sequence of frames, for example, an entire movie or television program may utilize a single collection of specifications defined by the sequence header. However, in other circumstances, the specifications defined by the sequence header may change (e.g, during a program or movie, or to change the parameters used to decode a commercial, etc.).

In order for a decoder to properly decode a sequence of frames, the proper sequence header is needed. Otherwise, the decoder will not know how to properly decode the frames to follow. A single sequence header could be used as the header for numerous frames, even an entire movie, or it could change. The sequence header information (carried as it's payload) is generally repeated on a relatively frequent basis, for example, at each MPEG I frame or each group of pictures (GOP).

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 illustrates an example of sequence header sequence number (SHSN) indexing in a manner consistent with certain embodiments of the present invention.

FIG. 2 illustrates an exemplary index of frames to SHSN in a manner consistent with certain embodiments of the present invention.

FIG. 3 is an example functional block diagram of a sequence indexing system consistent with certain embodiments of the present invention.

FIG. 4 is an exemplary process for indexing sequence headers in a manner consistent with certain embodiments of the present invention.

FIG. 5 is a functional block diagram illustrating playback using SHSN indexing in a manner consistent with certain embodiments of the present invention.

FIG. 6 is an illustrative playback sequence used to describe the playback process in a manner consistent with certain embodiments of the present invention.

FIG. 7 is a flow chart of an exemplary playback process consistent with certain embodiments of the present invention.

### DETAILED DESCRIPTION

While this invention is susceptible of embodiment in many different forms, there is shown in the drawings and will herein be described in detail specific embodiments, with the understanding that the present disklosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

As previously noted, sequence headers are used in MPEG compliant video formats to provide certain data used for decoding and presentation of a video image. Equivalent headers used in other video formats will be considered sequence headers for purposes of the present diskussion. In order for a decoder to properly decode a sequence of frames, the proper sequence header is needed. Otherwise, the decoder will not know which parameters to use in decoding the frames to follow. Whenever the sequence header changes, the new sequence header is loaded into the decoder so that the decoder can know how to decode subsequent frames during normal forward playback. However, when MPEG video data (or equivalent) is stored in a personal video recorder (PVR—also referred to as a digital video recorder or DVR), the user expects to be able to randomly access any saved programming. PVR's are used to store digital video content using digital technologies such as hard disk drives. The user of a PVR expects to be able to utilize so called “trick play” modes (fast forward, fast reverse, jump, skip, etc.) functions that mimic functions of analog video tape recorders.

In such trick play applications, the user could easily jump from one frame of video that operates according to a first sequence header to a frame of video that is part of a different video sequence, and thus requires a different set of sequence header data in order for the decoder to properly operate. If this happens, either the decoder will fail to properly decode the new frame or substantial delays in presentation of the image may occur while the video decoder searches for the proper sequence header.

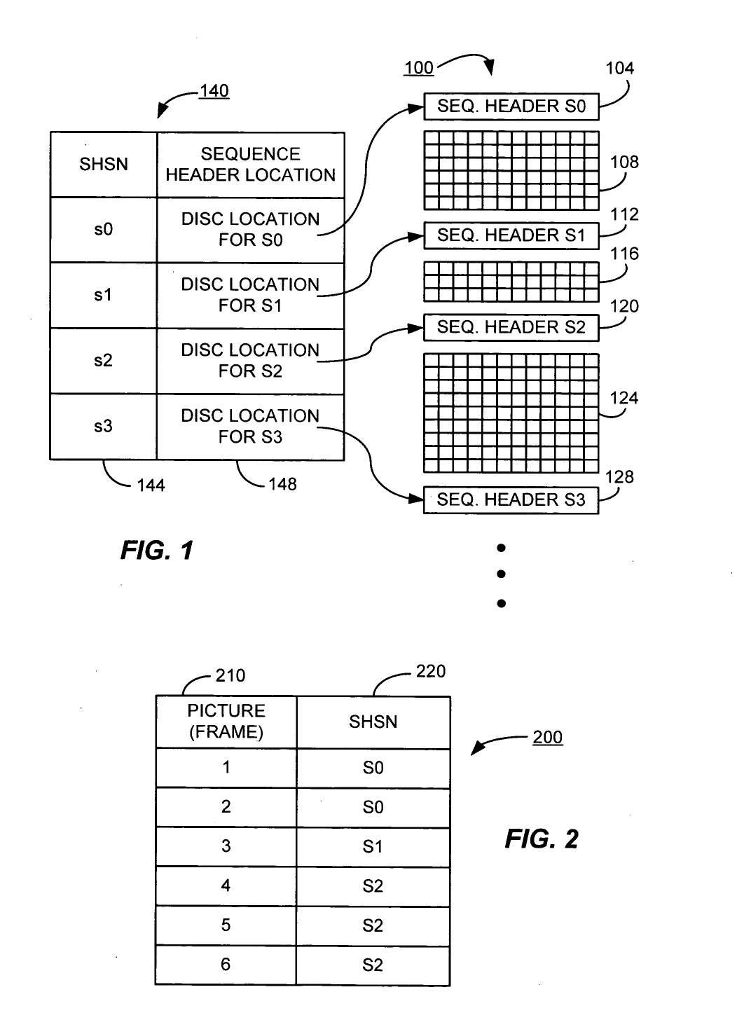

Turning now to FIG. 1, this problem can be addressed by use of an indexing system (shown in exemplary form in this figure) to assure that the decoder can always rapidly find the appropriate sequence header for a particular frame of video. A particular set of data that represents a video data stream can be visualized as stream 100 stored in a file on a disk drive of a PVR. Forward time movement is shown from top to bottom. This stream, in the portion shown, has a first sequence header 104 identified as S0, which provides information for sequence 108. Sequence header 112 (S1), provides information for sequence 116. Sequence header 120 (S2), provides information for sequence 124. Sequence header 128 (S3), provides information for a subsequent sequence (not shown). By way of example, sequence header 104 may be repeated a number of times within sequence 108, or may be the only sequence header provided for this sequence.

In accordance with certain embodiments consistent with the present invention, in order to provide rapid access to the appropriate sequence header data, each unique sequence header is indexed in an index table such as table 140 to a sequence header identifier referred to herein as a Sequence Header Sequence Number (SHSN). In this example table, SHSN is stored in column 144 and a disk location for the sequence header information is stored in column 148. Thus, for sequence 108, having sequence data in sequence number 104, a SHSN of s0 can be assigned that identifies a location on the disk drive of the PVR where the data associated with sequence header 104 is stored. This location, for example, can be specified by an absolute address or by an offset from a reference address using, for example, one byte of information. In this manner, as soon as a proper sequence header is identified, its data can be retrieved rapidly in order to process a particular picture (frame) or collection of pictures (sequence or sub-sequence).

FIG. 2 shows an example of a further indexing table 200 that is used in conjunction with index 140 (or alternatively, the two tables can be combined or otherwise related). In this table 200, each picture (frame) in the stream 100 is indexed to an SHSN identifier, with the picture or frame identifier stored in column 210 and the SHSN stored in column 220. In this example, the first two frames (pictures 1 and 2) are indexed to SHSN s0. Picture 3 is indexed to s1; and pictures 4, 5 and 6 are indexed to SHSN s2. Thus, using this index, a picture to be displayed (e.g., after the user initiates a jump in frames, as for example, in a trick mode) can be quickly associated first with an SHSN and then with an appropriate set of data from a sequence header via the SHSN. Alternatively, the SHSN can be integrated with the frame data or group of pictures (GOP) data for storage so that each frame or GOP is self-associated with the SHSN.

Thus, a computer readable data structure for a stored stream of video consistent with certain embodiment has a segment of data representing frames of video data; a plurality of sequence headers; a plurality of sequence header identifiers; an index table that indexes the sequence header identifiers to the sequence headers; and data that indexes the sequence header identifiers to the frames of video data.

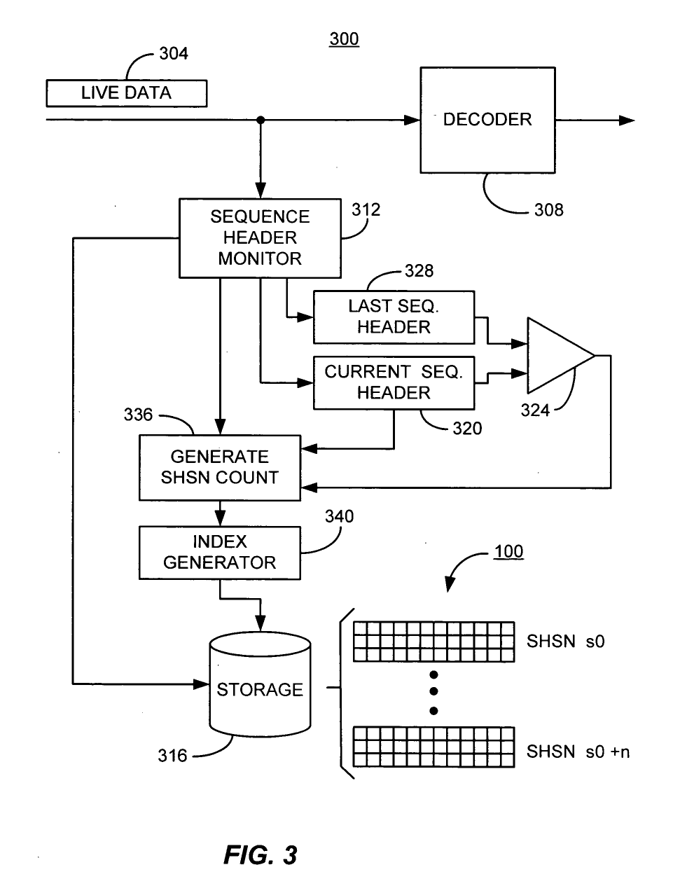

An exemplary apparatus for appropriate indexing and storage of such information is depicted in functional block diagram form in FIG. 3 as system 300. In this embodiment, live data 304, which may be received from any suitable source (e.g., cable TV) may be monitored on its way to a decoder 308 by a sequence header monitor 312 before the live data is passed along to a storage device such as a hard disk drive 316. The sequence header monitor 312, upon detecting a sequence header, buffers the sequence header so that the current sequence header 320 can be compared at 324 with the prior most recently received sequence header 328 (this prior sequence header may be stored and retrieved from the decoder itself). Whenever a new sequence header is encountered (i.e., current sequence header≠prior sequence header) a new SHSN count is generated (e.g., by incrementing) at 336. This count is passed along to an index generator 340 which generates the index tables such as 140 and 200 (or some equivalent tracking mechanism). In this manner the data stream stores the data stream 100 along with an SHSN that permits rapid retrieval of the appropriate sequence header (or the data from the sequence header).

Thus, an apparatus for storing a video stream consistent with certain embodiments has a sequence header monitor that identifies a sequence header in the video stream. A comparator compares the identified sequence header with a current sequence header. A sequence header identifier generator generates a new sequence header identifier whenever the comparator indicates that a new sequence header has been encountered. An index generator generates an index that relates the sequence header identifier to the sequence header. The index and a reference to the sequence header identifier are stored in a manner that associates the video data with the sequence header identifier along with the stream of video.

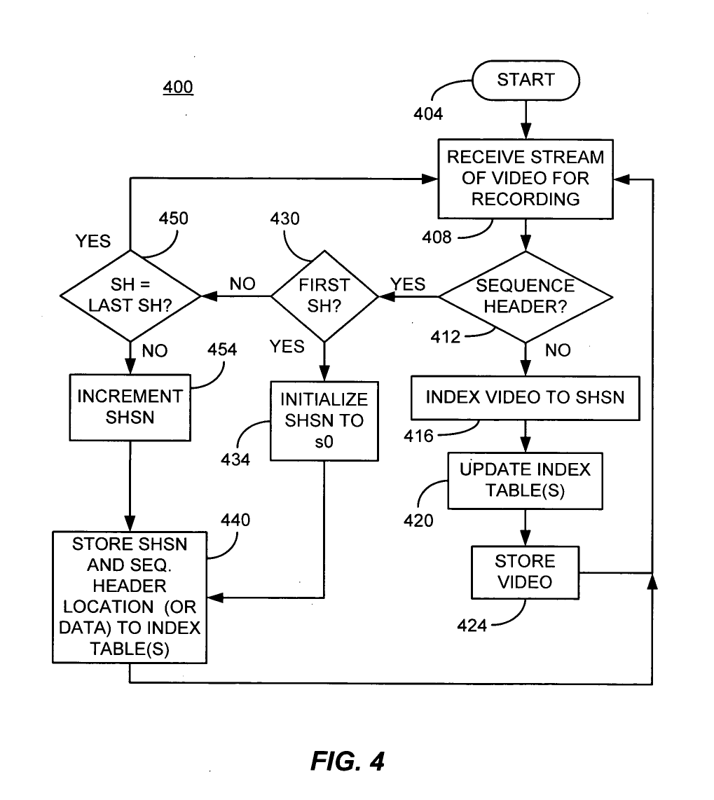

The process carried out by this system, or similar system, is depicted as process 400 of FIG. 4, starting at 404. During receipt of a stream of live video for recording, at 408, the stream is monitored for sequence headers. When a new sequence header is not detected at 412, the video frames are indexed to the current SHSN at 416. The index tables are updated at 420 and the video is stored at 424. Control is then returned to 408 where more video data are received.

If a sequence header is encountered at 412, and it is the first sequence header at 430, this sequence header is indexed to an initial SHSN number (s0) at 434 and the SHSN is stored along with the sequence header location (or data) to an index table at 440. Control then returns to 408.

If the sequence number is not the first sequence number at 430, the sequence header is checked at 450 to determine if it is new. In this example, this is accomplished by comparison with the most recent sequence header's payload. If there has been no change in the sequence header at 450, control returns to 408. If the sequence header has changed at 450, the SHSN is incremented at 454 and control passes to 440 where the SHSN is stored in the index tables to appropriately index subsequent frames with the proper sequence header in the manner previously described.

Therefore, when a recording session is initiated, the SHSN is initiated. When a different sequence header is encountered, the SHSN is incremented and the new SHSN is stored in the catalog of data for each picture header as the recorder stores the live picture stream.

Thus, a method of storing a video stream consistent with certain embodiments involves assigning a sequence header identifier to each sequence of video in the video stream that uses the same sequence header payload; storing the sequence header identifier in an index table that indexes the sequence header identifier to the sequence header; and storing a reference to the sequence header identifier in a manner that associates the video data with the sequence header identifier.

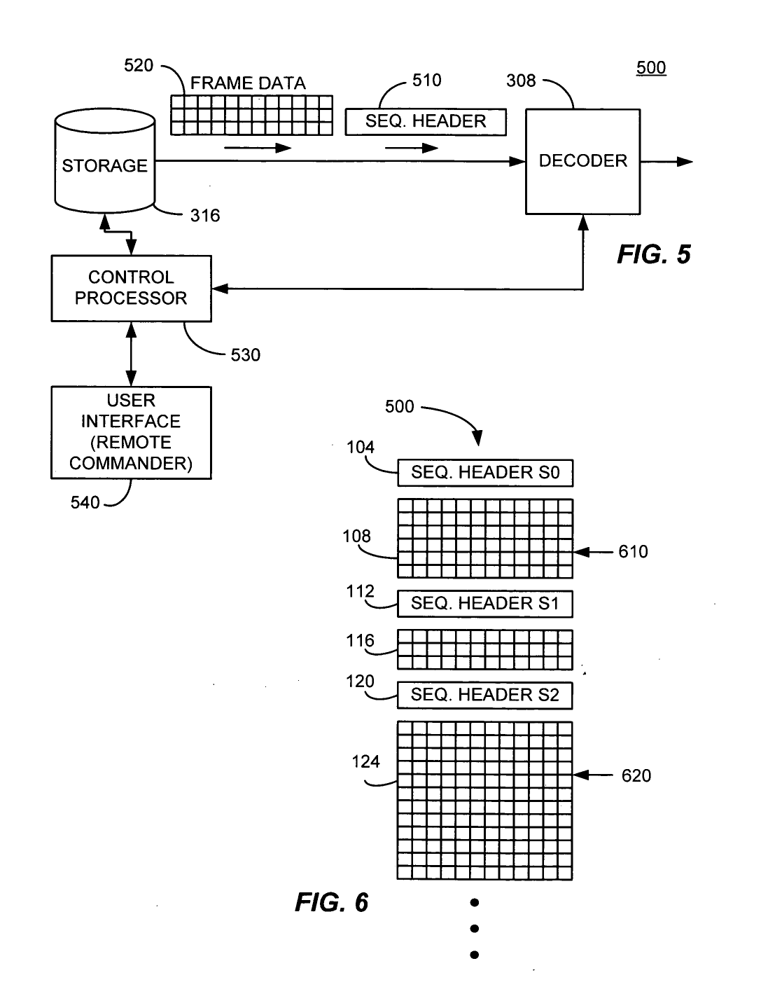

With reference to the playback arrangement 500 of FIG. 5, and as previously noted, when a stream of video is being played out from storage 316, the stream is passed to decoder 308. Decoder 308 needs to receive the sequence header 510 associated with frame data 520 prior to receipt of the frame data 520 in order to properly decode the frame data 520.

Now consider video stream 500 as shown in FIG. 6. If the stream is being decoded at decoder 308, suppose the user initiates an instruction (e.g., initiates a trick play mode), via a control processor 530 (i.e., using a user interface 540 such as a remote controller or a control panel instruction) that causes the playback to jump from the current frame at 610 to a new frame at 620. Prior to the instruction, the decoder was loaded with control parameters from sequence header 104. If the data in sequence header 104 is different than that of sequence header 120, the decoder 308 cannot display the frames starting at 620 without first finding and retrieving data from the sequence header 120 and loading the decoder 308 with that data.

In accordance with certain embodiments consistent with the present invention, this process is accelerated by reference to the index tables built in the manner previously described. When playback is initiated, the SHSN counter is initialized. When the player finds an entry in the saved catalog data it also extracts the SHSN number for the frame. If the extracted SHSN is different from the one the player has already fed to the decoder, then a new sequence header is needed. This new sequence header is then found via the index tables.

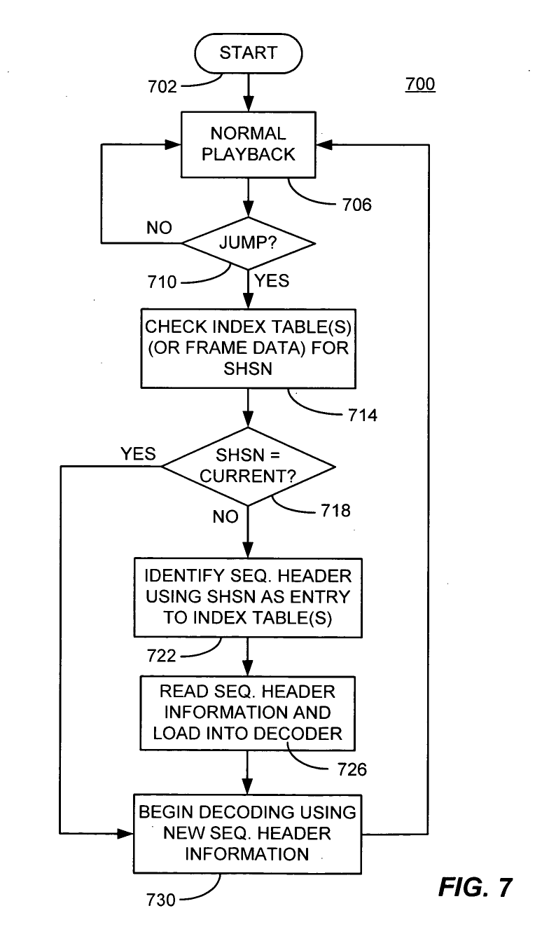

An exemplary embodiment of this process is described as process 700 of FIG. 7 starting at 702. When normal playback is occurring, or any other playback using a particular sequence header at 706, and a command that requires a jump is initiated at 710, the index tables or frame data or catalog is inspected at 714 for the most recent SHSN. If this SHSN does not correspond the currently loaded SHSN in the decoder, the correct sequence header is identified at 722 using the SHSN as an entry point to the index table(s). The correct sequence header information is then read at 726 and loaded into the decoder. The decoding can then proceed at 730 using the updated sequence header information.

Thus, method of playing the stored video according to certain embodiments involves determining that a command that calls for a jump to a new frame of the stored video has been issued; identifying a sequence header identifier associated with the new frame of video; finding a sequence header associated with the sequence header identifier; loading the sequence header's payload into a decoder; and decoding the new frame of video.

Those skilled in the art will recognize, upon consideration of the above teachings, that certain of the above exemplary embodiments are based upon use of a programmed processor such as processor 530, or processors carrying out the functions of certain of the blocks in FIG. 3. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disk storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain embodiments herein were described in conjunction with specific circuitry that carries out the functions described, other embodiments are contemplated in which the circuit functions are carried out using equivalent software or firmware embodiments executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

Software and/or firmware embodiments may be implemented using a programmed processor executing programming instructions that in certain instances are broadly described above in flow chart form that can be stored on any suitable electronic or computer readable storage medium (such as, for example, disk storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of storing a video stream, comprising:
assigning a sequence header identifier to each sequence of video in the video stream that uses the same sequence header payload;
storing the sequence header identifier in an index table that indexes the sequence header identifier to the sequence header; and
storing a reference to the sequence header identifier in a manner that associates the video data with the sequence header identifier.

2. The method according to claim 1, further comprising determining if a sequence header payload has changed by reading the video stream to identify a sequence header; and when a sequence header is identified, determining if the sequence header payload has changed since a previous sequence header was read.

3. The method according to claim 1, wherein the assigning comprises determining that a new sequence header payload has been encountered; incrementing a sequence header sequence number (SHSN) whenever the sequence header payload changes; and assigning the SHSN as the sequence identifier.

4. The method according to claim 1, wherein storing a reference to the sequence header identifier in a manner that associates the video data with the sequence header identifier comprises storing a sequence header identifier along with each frame of video.

5. The method according to claim 1, wherein storing a reference to the sequence header identifier in a manner that associates the video data with the sequence header identifier comprises storing a sequence header identifier along with each group of pictures.

6. The method according to claim 1, wherein storing a reference to the sequence header identifier in a manner that associates the video data with the sequence header identifier comprises storing an index table that relates each frame of video to a sequence header identifier.

7. The method according to claim 1, carried out on a programmed processor.

8. A computer readable storage medium storing instructions that, when executed on a programmed processor carry out the process according to claim 1.

9. A computer implemented method of storing a video stream, comprising:
determining if a sequence header payload has changed by reading the video stream to identify a sequence header, and when a sequence header is identified, determining if the sequence header payload has changed since a previous sequence header was read;
assigning an sequence header sequence number (SHSN) to each sequence of video in the video stream that uses the same sequence header payload, by incrementing the SHSN whenever the sequence header payload changes;
storing the SHSN in an index table that indexes the SHSN to the sequence header; and
storing a reference to the SHSN in a manner that associates the video data with the SHSN.

10. The method according to claim 9, wherein storing a reference to the SHSN in a manner that associates the video data with the sequence header identifier comprises storing an SHSN along with each frame of video.

11. The method according to claim 9, wherein storing a reference to the SHSN in a manner that associates the video data with the sequence header identifier comprises storing an SHSN along with each group of pictures.

12. The method according to claim 9, wherein storing a reference to the SHSN in a manner that associates the video data with the SHSN comprises storing an index table that relates each frame of video to an SHSN.

13. A computer readable storage medium storing instructions that, when executed on a programmed processor carry out the process according to claim 9.

14. An apparatus for storing a video stream, comprising:
a sequence header monitor that identifies a sequence header in the video stream;
a comparator that compares the identified sequence header with a current sequence header; and
a sequence header identifier generator that generates a new sequence header identifier whenever the comparator indicates that a new sequence header has been encountered;
an index generator that generates an index that relates the sequence header identifier to the sequence header; and
means for storing the index and a reference to the sequence header identifier in a manner that associates the video data with the sequence header identifier along with the stream of video.

15. The apparatus according to claim 14, wherein when the comparator determines that a new sequence header payload has been encountered, the sequence header identifier generator increments a sequence header sequence number (SHSN) and whenever the SHSN is assigned as the sequence identifier.

16. The apparatus according to claim 14, wherein the means for storing stores a sequence header identifier along with each frame of video.

17. The apparatus according to claim 14, wherein the means for storing stores a sequence header identifier along with each frame of video.

18. The apparatus according to claim 14, wherein the means for storing stores an index table that relates each frame of video to a sequence header identifier.

19. The apparatus according to claim 14, further comprising a programmed processor, and wherein at least one of the sequence header monitor, the comparator, the sequence header identifier generator, the index generator, and the means for storing are implemented as programmed processes running on the programmed processor.

20. A computer readable data structure for a stream of video, comprising:
a segment of data representing frames of video data;
a plurality of sequence headers;
a plurality of sequence header identifiers;
an index table that indexes the sequence header identifiers to the sequence headers; and
data that indexes the sequence header identifiers to the frames of video data.

21. The data structure according to claim 20, wherein the data that indexes the sequence header identifiers to the frames of video data comprises a data table.

22. The data structure according to claim 20, wherein the data that indexes the sequence header identifiers to the frames of video data comprises a segment of data carrying the sequence header identifier that is associated with each frame of video data.

23. The data structure according to claim 20, wherein the data that indexes the sequence header identifiers to the frames of video data comprises a segment of data carrying the sequence header identifier that is associated with each group of pictures.

24. A computer readable storage medium storing data having the data structure according to claim 20.

25. A method of playing stored video, comprising:
determining that a command that calls for a jump to a new frame of the stored video has been issued;
identifying a sequence header identifier associated with the new frame of video;
finding a sequence header associated with the sequence header identifier;
deciding whether a new sequence header should be loaded or not by comparing a current sequence header sequence and a sequence header identifier of target video frame;
loading the sequence header's payload into a decoder; and
decoding the new frame of video.

26. The method according to claim 25, wherein the finding is carried out by referring to an index table that indexes the sequence header identifier to a sequence header.

27. The method according to claim 25, wherein the sequence header identifier comprises a sequence header sequence number (SHSN).

28. The method according to claim 25, wherein the sequence header identifier is stored in index information along with each video frame entry in the index table.

29. The method according to claim 25, wherein an index table relates each frame of video to a sequence header identifier.

30. The method according to claim 25, wherein the determining is carried out by receipt of a command from a user interface.

31. The method according to claim 25, wherein the command comprises a trick play command.

32. The method according to claim 25, carried out on a programmed processor.

33. A computer readable storage medium storing instructions that, when executed on a programmed processor carry out the process according to claim 25.

34. A computer implemented method of playing stored video, comprising:
determining that a trick play command that calls for a jump to a new frame of the stored video has been issued at a user interface;
identifying a sequence header sequence number (SHSN) associated with the new frame of video;
finding a sequence header associated with the SHSN by referring to an index table that indexes the SHSN to a sequence header;
loading the sequence header's payload into a decoder; and
decoding the new frame of video.

35. The method according to claim 34, wherein the sequence header identifier is stored in index information along with each video frame entry in the index table.

36. An apparatus for playing stored video, comprising:
a user interface that issues a command that calls for a jump to a new frame of the stored video;
a video decoder; and
a programmed processor that identifies a sequence header identifier associated with the new frame of video, finds a sequence header associated with the sequence header identifier, and loads the sequence header's payload into the decoder.

37. The apparatus according to claim 36, wherein the programmed processor finds the sequence header by referring to an index table that relates the sequence header identifier to a sequence header.

38. The apparatus according to claim 36, wherein the sequence header identifier comprises a sequence header sequence number (SHSN).

39. The apparatus according to claim 36, wherein an index table relates each frame of video to a sequence header identifier.

40. The apparatus according to claim 36, wherein the command comprises a trick play command.
